(19) United States
(12) Patent Application Publication
(10) Pub. No.: US 2010/0063187 A1
(43) Pub. Date: Mar. 11, 2010

(54) COMPOSITIONS CONTAINING PHOSPHONATE-FUNCTIONAL PARTICLES

(75) Inventors: Christoph Briehn, Zeilarn (DE); Martina Baumann, Sauerlach (DE); Silvia Jung-Rossetti, Munich (DE); Volker Stanjek, Ampfing (DE)

Correspondence Address: BROOKS KUSHMAN P.C., 1000 TOWN CENTER, TWENTY-SECOND FLOOR, SOUTHFIELD, MI, 48075, US

(73) Assignee: WACKER CHEMIE AG, Munich (DE)

(21) Appl. No.: 12/513,607

(22) PCT Filed: Oct. 22, 2007
(86) PCT No.: PCT/EP07/61257

§ 371 Date: May 5, 2009

(30) Foreign Application Priority Data
Nov. 10, 2006 (DE) 10 2006 053 156.6

(51) Int. Cl. C08K 5/53

(52) U.S. Cl. 524/130

(57) ABSTRACT

Phosphonatoalkylsilyl-functional particles have high stability and resistance to agglomeration. When used in curable binder compositions, the particles contribute to a high level of scratch resistance.

The invention relates to compositions comprising phosphonate-functional particles, to composite materials produced therefrom, and to the use of the compositions.

Composite materials comprising particles—more particularly nanoparticles—are state of the art. Corresponding coatings comprising composite materials are described for example in EP 1 249 470, WO 03/16370, US 20030194550 or US 20030162015. The particles therein lead to an improvement in the properties of the corresponding coatings, more particularly with regard to their scratch resistance and also, where appropriate, their chemical resistance.

A frequently occurring problem associated with the use of the—generally inorganic—particles in organic matrix systems lies in a usually inadequate compatibility between particle and matrix. This can lead to the particles being insufficiently dispersible in the matrix. Moreover, even well-dispersed particles may undergo settling in the course of prolonged standing times or storage times, with the formation, possibly, of larger aggregates or agglomerates, which even through an input of energy are impossible or difficult to separate into the original particles. The processing of such inhomogeneous systems is extremely difficult in any case, and in fact is often impossible. Composite materials which, following their application and curing, possess smooth surfaces cannot generally be produced by this route, or can be produced only by cost-intensive processes.

It is therefore beneficial to use particles which on their surface possess organic groups which lead to improved compatibility with the surrounding matrix and thus suppress unwanted agglomeration or aggregation of the particles. In this way the inorganic particle becomes masked by an organic shell. Particularly beneficial composite properties can frequently be achieved, moreover, if the organic functions on the particle surfaces are also reactive toward the matrix, and so are able to react with the matrix under the particular conditions of curing. In this way, success is achieved in incorporating the particles into the matrix chemically in the course of the curing of the composite, something which often results in particularly good mechanical properties but also in an improved chemical resistance. Systems of this kind are described for example in DE 102 47 359 A1, EP 0 832 947 A1 or EP 0 872 500 A1.

A disadvantage is the stability, inadequate in spite of the masking, of the nanoparticles used in the prior art. This insufficient stability on the part of the particles is manifested first during the processing of the particles, particularly when the particle dispersions are being concentrated or when the solvent is being replaced, and secondly during the storage of the uncured particle dispersions. Signs of inadequate stability of the particles are an increase in viscosity, frequently proceeding to the point of gelling, or the sedimentation of the particles. Moreover, owing to the high propensity toward agglomeration or aggregation, it is not possible to isolate the described nanoparticles in the form of redispersible solids.

On isolation, such as by spray drying, for example, the particles which can be produced in accordance with the prior art are obtained as particle agglomerates or particle aggregates which cannot be redispersed, even with energy input by means, for example, of a bead mill or through ultrasound treatment, to achieve the original primary particle size. Such redispersion, however, would be particularly desirable in view of the storage and transport and, more particularly, for possible processing of the powders in extrusion operations.

According to the prior art, the surface-modified particles included in the composite materials are produced by reacting particles that possess free silanol (SiOH) or metal-hydroxide functions with alkoxysilanes or their hydrolysis and condensation products that contain unreactive groups, such as alkyl or aryl radicals, for example, or reactive organic functions, such as vinyl, (meth)acryloyl, carbinol, etc, for example. The silanes used for particle functionalization in the prior art are typically di- or trialkoxysilanes.

Where these silanes are used for surface functionalization, a siloxane shell is formed around the particle in the presence of water, following hydrolysis and condensation of the silanols obtained. Macromol. Chem. Phys. 2003, 204, 375-383 describes the formation of a siloxane shell of this kind around an SiO₂ particle. A problem here can be that the siloxane shell which is formed still possesses a large number of SiOH functions on the surface. The stability of such SiOH-functional particles is frequently only limited under the conditions of production and storage, even in the presence of the binder.

The production of core-shell particles which on their surface are free from alkoxysilyl groups and silanol groups and which, consequently, have a lower propensity toward agglomeration is taught by the specifications EP 0 492 376 A and DE 10 2004 022 406 A. For this purpose, in a first step, different silanes and siloxanes, where at least one silane or siloxane carries methacryloyl groups, are cocondensed to produce a siloxane particle onto which, in the next step, by reaction with methyl methacrylate, a polymethyl methacrylate shell is grafted. The particles obtained exhibit outstanding compatibilities in organic polymers such as, for example, polymethyl methacrylate and PVC. These siloxane graft polymers have the advantage, moreover, that, given suitable composition and thickness of the grafted shell, they are redispersible. They possess the disadvantage, however, of being relatively complicated to produce, resulting in high production costs.

On account of their broad utility, particle-reinforced coating materials, described for example in

EP 0 768 351, EP 0 832 947, EP 0 872 500 or DE 10247359, are a particularly important type of composite materials. As reinforcing fillers they use surface-modified particles which exhibit sufficient compatibility with the coating matrix. Through the introduction of the surface-modified particles it is possible in particular to achieve a marked increase in the scratch resistance of coating materials. Nevertheless, the handling of the particles, particularly when they are present in the form of a highly concentrated dispersion, is extremely difficult on account of their above-described restricted stability. Moreover, it is not possible to isolate the particles, since the agglomerates that form in the course of drying cannot be separated again into the original particle size, i.e., the size of the primary particles. Moreover, the mechanical hardnesses—and especially the scratch resistances—of the particle-reinforced coating materials are still not sufficient for numerous applications.

In the case of one particularly important type of coating material for which a further improvement in scratch resistance is aimed at through addition of particles, a film-forming resin is used which comprises hydroxy-functional prepolymers, more particularly hydroxy-functional polyacrylates and/or polyesters, which on curing of the coating material are brought to reaction with an isocyanate-functional curing agent (polyurethane coating materials) and/or with a melamine curing agent (melamine coating materials). The polyurethane coating materials feature particularly good properties. For instance, polyurethane coating materials possess in particular a superior chemical resistance, while the melamine coating materials generally possess better scratch resistances. These types of coating material are typically used in particularly high-value and demanding fields of application: for example, as clearcoat and/or topcoat materials for OEM paint systems in the automobile and vehicle industry. The majority of topcoats for automotive refinishes also consist of systems of this kind. The film thicknesses of these coatings are situated typically in ranges from 20 to 50 μm.

In the case of the polyurethane coating systems a distinction is generally made between what are called the 2K and 1K systems. The former consist of two components, of which one is composed essentially of the isocyanate curing agent, while the film-forming resin with its isocyanate-reactive groups is included in the second component. Both components in this case must be stored and transported separately and should not be mixed until shortly before they are processed, since the pot life of the completed mixture is greatly limited. Often more beneficial, therefore, are the 1K systems, which consist only of one component, in which, alongside the film-forming resin, there is a curing agent with protected isocyanate groups. 1K coating materials are cured thermally, the protective groups of the isocyanate units being eliminated, and the deprotected isocyanates being then able to react with the film-forming resin. Typical baking temperatures of such 1K coating materials are 120-160° C. Melamine coating materials are generally 1K coating materials; the baking temperatures are typically situated in a comparable temperature range.

In the case of these high-value coating materials in particular, a further improvement in properties would be desirable. This is true more particularly of vehicle finishes. For instance, the attainable scratch resistance of conventional auto paints, in particular, is still not sufficient, with the consequence, for example, that particles in the wash water in a car wash lead to significant scratching of the finish. Over time, this causes lasting damage to the gloss of the finish. In this situation, formulations that allow better scratch resistances to be achieved would be desirable.

One particularly advantageous way of achieving this object is to use particles having, on their surface, organic functions which are reactive toward the film-forming resin or else toward the curing agent. Moreover, these organic functions on the particle surface lead to masking of the particles and so enhance the compatibility between particle and film-forming matrix.

Particles of this kind with suitable organic functions are already known in principle. They and their use in coatings are described for example in EP 0 768 351, EP 0 832 947, EP 0 872 500 or DE 10247359.

The scratch resistance of coatings can in fact be increased significantly through the incorporation of these kinds of particles. However, in all of the methods of using these particles that have been described in the prior art, optimum results have still not been achieved. In particular, the corresponding coatings have such high particle contents that on grounds of cost alone it would be difficult to realize the use of such coating materials in large-scale production-line coating systems.

WO 01/09231 describes particle-containing coating systems which are characterized in that there are more particles located in a surface segment of the coating than in a bulk segment. An advantage of this particle distribution is the comparatively low particle concentration which is needed for a marked improvement in scratch resistance. The desired high affinity of the particles for the coating surfaces is achieved in that a silicone resin is deposited on the particle surfaces as a surface active agent. A disadvantage of this method, however, is the fact that not only the silicone-resin modification of the particles but also the preparation of the silicone resins themselves that are required for that purpose are costly and inconvenient from a technical standpoint. A particular problem associated with the preparation of the silicone resins is the fact that the attainment of effective scratch resistance requires the silicone resins to be provided with organic functions, carbinol functions, for example, via which the particles thus modified can be incorporated chemically into the coating material when the latter is cured. Silicone resins functionalized in this way are available commercially not at all or only to a very restricted degree. In particular, however, the selection of organic functions that are possible at all in the context of this system is relatively limited. For this system, therefore, as also for all of the other prior-art systems, optimum results have still not been achieved.

It was an object of the invention, therefore, to develop a composition for a composite material that overcomes the disadvantages of the prior art.

The invention provides a composition (Z) comprising
(a) 0.02-200 parts by weight of particles (P) which contain at least one structural element of the general formula [1],

≡Si—L—P(O)(OR¹)₂ [1]
(b) 100 parts by weight of a binder (B),
(c) 0-100 parts by weight of a curing agent (H) which is reactive toward the binder (B), and
(d) 0-1000 parts by weight of a solvent or solvent mixture, where
L is a divalent aliphatic or aromatic hydrocarbon radical having 1 to 12 carbon atoms, whose carbon chain may be interrupted by nonadjacent oxygen atoms, sulfur atoms or NR² groups, and which is optionally substituted by carbinol, amino, halogen, epoxy, phosphonato, thiol, (meth)acrylato, carbamato groups,
R¹ is hydrogen, a metal cation, an ammonium cation of the formula —N(R²)₄⁺, phosphonium cation of the formula —P(R²)₄⁺ or an aliphatic or aromatic hydrocarbon radical having 1 to 12 carbon atoms, whose carbon chain may be interrupted by nonadjacent oxygen atoms, sulfur atoms or NR² groups, and which is optionally substituted by carbinol, amino, halogen, epoxy, phosphonato, thiol, (meth)acrylato, carbamato, ureido groups, and
R² is a hydrocarbon radical having 1-8 carbon atoms.

Composite materials (K) producible from the composition (Z) are likewise provided by the invention.

In one embodiment of the invention the particles (P) besides functions of the general formula [1] further contain at least one organofunctional group (F) which is reactive toward the binder (B) or the curing agent (H).

In one preferred embodiment of the invention the composite materials (K) are coating systems which are producible from a coating composition (Z) comprising
(a) 0.02-60 parts by weight of particles (P) which contain at least one structural element of the general formula [1],

≡Si—L—P(O)(OR¹)₂ [1]
(b) 100 parts by weight of a hydroxyl-functional film-forming resin (B),
(c) 1-100 parts by weight of a coatings curing agent (H) which contains isocyanate groups which are selected from free isocyanate groups and protected isocyanate groups which on thermal treatment eliminate a protective group to release an isocyanate function,
(d) 0-1000 parts by weight of a solvent or solvent mixture.

The invention is based on the finding that the composite materials (K) produced from the compositions (Z) exhibit outstanding mechanical properties. Moreover, owing to the high stability of the particles (P) included in the compositions (Z), the preparation of the compositions (Z) is much easier than in the prior-art processes. By virtue of the presence of the structural elements of the general formula [1], the particles (P) have an extremely low propensity toward agglomeration or aggregation, thus making it possible to handle the particles (P) in dispersions with high solids content. Depending on the nature of the particle modification, it is in some cases possible to isolate the particles (P) as a solid and to carry out their redispersion in the composition (Z).

The binder (B), the curing agent (H) and the particles (P)—insofar as they possess organofunctional groups

(F) which are reactive toward the binder or the curing agent—preferably possess a sufficient number of reactive groups to allow a three-dimensionally crosslinked polymer network to be formed when the compositions (Z) are cured to form the composite materials (K).

L is preferably a divalent alkyl radical having 1-8 carbon atoms or an aryl or heteroaryl radical having 1-10 carbon atoms; more preferably L is a methylene or propylene radical. R¹ is preferably an alkyl radical having 1-6 carbon atoms, more particularly methyl or ethyl radical. R² is preferably an alkyl radical, more particularly methyl, ethyl or butyl radical.

The composition (Z) preferably comprises at least 0.05 part by weight, more preferably at least 0.1 part by weight, of particles (P). In especially advantageous embodiments of the invention the composition (Z) comprises at least 0.3 part by weight, more particularly at least 0.5 part by weight, of particles (P).

The composition (Z) preferably comprises not more than 50 parts by weight, more preferably not more than 25 parts by weight, of particles (P). In especially advantageous embodiments of the invention the composition (Z) comprises not more than 10 parts by weight, more particularly not more than 5 parts by weight, of particles (P).

The particles (P) preferably possess a specific surface area of 0.1 to 1000 m²/g, more preferably of 10 to 500 m²/g (as measured by the BET method in accordance with DIN EN ISO 9277/DIN 66132). The average size of the primary particles is preferably less than 10 μm, more preferably less than 1000 nm, the primary particles being possibly present as aggregates (definition as per DIN 53206) and agglomerates (definition as per DIN 53206), which depending on the external shearing load (imposed by the conditions of measurement, for example), may have sizes of 1 to 1000 μm, and the average particle size is determined by means of transmission electron microscopy (TEM) or the hydrodynamic equivalent diameter by means of photon correlation spectroscopy.

One particular embodiment of the invention employs particles as described in WO 2004/089961 but additionally possessing structural elements of the general formula [1].

In the particles (P) the structural elements of the general formula [1] may be attached covalently, via ionic or van der Waals interactions. Preferably the structural elements of the general formula [1] are attached covalently.

In one preferred embodiment of the invention the particles (P) are reacted by reaction of particles (P1) having functions selected from metal-OH, metal-O-metal, Si—OH, Si—O—Si, Si—O-metal, Si—X, metal-X, metal-OR³, Si—OR³ with silanes (S), or their hydrolysis, alcoholysis, and condensation products, which possess at least one structural element of the general formula [1] and also possess at least one reactive silyl group

≡Si—Y

which are reactive toward the surface functions of the particle (P1),
where
R³ is an optionally substituted alkyl radical,
X is a halogen atom, and
Y is a halogen, a hydroxyl or alkoxy group, a carboxylate or an enolate.

R³ is preferably an alkyl radical having 1 to 10, more particularly 1 to 6, carbon atoms. Particularly preferred radicals are methyl, ethyl, n-propyl, and isopropyl. X is preferably fluorine or chlorine. The radicals Y are preferably a halogen or hydroxyl or alkoxy groups. With particular preference the radicals Y are chlorine atoms or hydroxyl, ethoxy or methoxy radicals.

Where the particles (P) are prepared using particles (P1) which contain functions selected from metal-OH, Si—OH, Si—X, metal-X, metal-OR³, Si—OR³, the attachment of the silanes (S) is through hydrolysis and/or condensation. Where the particle (P1) contains exclusively metal-O-metal, metal-O—Si or Si—O—Si functions, the covalent attachment of the silanes (S) may be through an equilibration reaction. The procedure and the catalysts that are needed for the equilibration reaction are familiar to the skilled worker and are widely described in the literature.

Alternatively the attachment of the structural elements of the general formula [1] may take place during particle synthesis.

In one preferred embodiment of the invention the silanes (S) that are used for modifying the particles (P1) have a structure of the general formula [2]

(R⁴O)₃₋ₐR⁴ₐSi—(CR⁵)ₙ—P(O)(OR⁶)₂ [2]

where
a denotes the values 0, 1 or 2 and
n denotes the values 1, 2 or 3,
R⁵ is hydrogen, an optionally substituted aliphatic or aromatic hydrocarbon having 1-6 carbon atoms, and
R⁴ and R⁶ have the definitions of R¹.

In this formula, n preferably adopts the value 1 or 3, more preferably the value 1. a preferably denotes the value 0 or 2; with particular preference a is 2. R⁴ is preferably a methyl or ethyl radical, R⁵ is preferably hydrogen, and R⁶ is preferably methyl or ethyl radical.

The silanes (S) that are used for modifying the particles (P1), and/or the hydrolysis or condensation products of said silanes, are used in this context preferably in an amount of greater than 1% by weight (based on the particles (P)), more preferably greater than 5% by weight, very preferably greater than 8% by weight.

In the preparation of the particles (P) from particles (P1) it is possible, as well as the silanes (S) and/or their hydrolysis and condensation products, to make use additionally of other silanes (S1), silazanes (S2), siloxanes (S3) or other compounds (L). Preferably the silanes (S1), silazanes (S2), siloxanes (S3) or other compounds (L) are reactive toward the functions of the surface of the particle (P). In this context the silanes (S1) and siloxanes (S3) possess either silanol groups or hydrolyzable silyl functions, the latter being preferred. The silanes (S1), silazanes (S2), and siloxanes (S3) may possess organic functions (F) which are reactive toward the binder (B) or the curing agent (H); alternatively it is possible to use silanes (S1), silazanes (S2), and siloxanes (S3) without organic functions. The silanes and siloxanes (S) may be used as a mixture with the silanes (S1), silazanes (S2), or siloxanes (S3). In addition, the particles may also be functionalized successively with the different types of silane.

Examples of suitable compounds (L) include metal alkoxides, such as titanium(IV) isopropoxide or aluminum(III) butoxide, for example, protective colloids such as polyvinyl alcohols, for example, cellulose derivatives or vinylpyrrolidone-containing polymers, and emulsifiers such as, for example, ethoxylated alcohols and phenols (alkyl radical C₄-C₁₈, EO degree 3-100), alkali metal salts and ammonium salts of alkyl sulfates (C₃-C₁₈), sulfuric esters and also phosphoric esters, and alkylsulfonates. Particular preference is given to sulfosuccinic esters and also alkali metal alkyl sulfates and also polyvinyl alcohols. It is also possible to use two or more protective colloids and/or emulsifiers in the form of a mixture.

The weight fraction of the silanes (S1), silazanes (S2), siloxanes (S3), and compounds (L) as a proportion of the total amount formed by the silanes (S) and (S1), silazanes (S2), siloxanes (S3), and compounds (L) is preferably at least 1% by weight, more preferably at least 5% by weight. In a further particularly preferred embodiment of the invention the use of the compounds (S1), (S2), (S3), and (L) is omitted completely.

Particular preference is given in this context to mixtures of silanes (S) with silanes (S1) of the general formula [3]

(R⁷O)_{4-a-b}(Z)ₐSi(R⁸)_{b} [3]

and/or their hydrolysis or condensation products, where
Z is halogen atom, pseudohalogen radical, Si—N— bonded amine radical, amide radical, oxime radical, amineoxy radical or acyloxy radical,
a is 0, 1, 2 or 3,
b is 0, 1, 2 or 3,
R⁷ has the definitions of R¹,
R⁸ is an aliphatic or aromatic hydrocarbon radical having 1 to 12 carbon atoms, whose carbon chain may be interrupted by nonadjacent oxygen atoms, sulfur atoms or NR² groups, and which optionally has an organofunctional group (F) as well which is reactive toward the binder (B) or the curing agent (H), and
a+b is less than or equal to 4.

Here, a is preferably 0, 1 or 2, while b is preferably 0 or 1. R⁷ is preferably a methyl or ethyl radical. Z is preferably a chlorine atom. R⁸ is preferably a radical containing functional groups of the carbinol, amine, (meth)acrylate, epoxy, thiol, isocyanato, ureido and/or carbamate type.

Silazanes (S2) or siloxanes (S3) used with particular preference are hexamethyldisilazane or hexamethyl-disiloxane or linear siloxanes which carry organofunctional groups terminally or pendently.

Particular preference is given to the silanes (S1) which carry an organofunctional group (F) reactive toward the binder (B) or curing agent (H). Examples of such silanes (S1) are amino-functional silanes, such as, for example, aminopropyltrimethoxysilane, cyclo-hexylaminomethyltrimethoxysilane, phenylaminomethyl-trimethoxysilane, silanes with unsaturated functions, such as, for example, vinyltrimethoxysilane, methacrylatopropyltrimethoxysilane, methacrylato-methyltrimethoxysilane, epoxy-functional silanes, such as, for example, glycidyloxypropyltrimethoxysilane, mercapto-functional silanes, such as, for example, mercaptopropyltrimethoxysilane, silanes which possess a masked NCO group and on thermal treatment eliminate the protective group to release an NCO function, and silanes which in the course of reaction with a particle (P1) release carbinol functions or amine functions.

For reasons of technical manageability, suitable particles (P1) are oxides with a covalent bonding component in the metal-oxygen bond, preferably oxides of main group 3, such as boron oxides, aluminum oxides, gallium oxides or indium oxides, of main group 4, such as silicon dioxide, germanium dioxide, tin oxide, tin dioxide, lead oxide, lead dioxide, or oxides of transition group 4, such as titanium oxide, zirconium oxide, and hafnium oxide. Further examples are oxides of nickel, of cobalt, of iron, of manganese, of chromium, and of vanadium.

Additionally suitable are metals with an oxidized surface, zeolites (a listing of suitable zeolites is found in: Atlas of Zeolite Framework Types, 5^{th} edition, Ch. Baerlocher, W. M. Meier, D. H. Olson, Amsterdam: Elsevier 2001), silicates, aluminates, alumino-phosphates, titanates, and aluminum phyllosilicates (e.g., bentonites, montmorillonites, smectites, hectorites), the particles (P1) preferably having a specific surface area of 0.1 to 1000 m²/g, more preferably of 10 to 500 m²/g (as measured by the BET method in accordance with DIN 66131 and 66132). The particles (P1), which preferably have an average diameter of less 10 μm, more preferably less than 1000 nm, may be present in the form of aggregates (definition as per DIN 53206) and agglomerates (definition as per DIN 53206) which, depending on the external shearing load (imposed by the conditions of measurement, for example), may have sizes of 1 to 1000 μm. The average particle size is determined by means of transmission electron microscopy (TEM) or the hydrodynamic equivalent diameter by means of photon correlation spectroscopy.

In one preferred embodiment of the invention, particles (P1) used are colloidal silicon oxides or metal oxides, which in general are present in the form of a dispersion of the corresponding oxide particles of submicron size in an aqueous or organic solvent. In this case it is possible to use, among others, the oxides of the metals aluminum, titanium, zirconium, tantalum, tungsten, hafnium, and tin, or the corresponding mixed oxide. Silica sols are particularly preferred. In general the silica sols are solutions with a strength of 1-50% by weight, preferably solutions with a strength of 20-40% by weight. Typical solvents in this case, as well as water, are especially alcohols, more particularly alcohols having 1 to 6 carbon atoms, frequently isopropanol, but also other alcohols, usually of low molecular mass, such as methanol, ethanol, n-propanol, n-butanol, isobutanol, and tert-butanol, for example. Also available are organosols in polar aprotic solvents such as methyl ethyl ketone, for example, or aromatic solvents such as toluene, for example. The average particle size of the silicon dioxide particles (P1) is generally 1-100 nm, preferably 5-50 nm, more preferably 8-30 nm.

Examples of commercially available silica sols that are suitable for producing the particles (P) are silica sols of the product series LUDOX® (Grace Davison), Snowtex® (Nissan Chemical), Klebosol® (Clariant), and Levasil® (H. C. Starck), silica sols in organic solvents, such as IPA-ST (Nissan Chemical), for example, or those silica sols which can be prepared by the Stöber process.

Starting from the colloidal silicon oxides or metal oxides (P1), the particles (P) can be produced by a variety of methods. Preferably, however, preparation takes place by addition of the silanes (S) and/or their hydrolysis or condensation products—where appropriate in a solvent and/or in mixtures with other silanes (S1), silazanes (S2), or siloxanes (S3)—to the particle (P1) and/or to its solution in an aqueous or organic solvent. The reaction takes place in general at temperatures of 0-200° C., preferably at 20-80° C., and more preferably at 20-60° C. The reaction times are typically 5 min to 48 h, preferably 1 to 24 h. Alternatively it is also possible to add acidic or basic catalysts or catalysts containing heavy metal. These catalysts are used preferably in traces (<1000 ppm). With particular preference, however, the addition of separate catalysts is omitted.

Where appropriate, the addition of water is preferred for the reaction of the particles (P1) with the silanes (S).

Since colloidal silicon oxides or metal oxides are often present in aqueous or alcoholic dispersion, it may be advantageous to replace the solvent or solvents, during or after the production of the particles (P), by another solvent or solvent mixture. This can be done, for example, by distillative removal of the original solvent, the new solvent or solvent mixture being able to be added in one step or else in two or more steps before, during or else only after the distillation. Suitable solvents in this context may be, for example, water, aromatic or aliphatic alcohols, preference being given to aliphatic alcohols, especially aliphatic alcohols having 1 to 6 carbon atoms (e.g., methanol, ethanol, n-propanol, isopropanol, n-butanol, isobutanol, tert-butanol, the various regioisomers of pentanol and of hexanol), esters (e.g., ethyl acetate, propyl acetate, butyl acetate, butyldiglycol acetate, methoxypropyl acetate), ketones (e.g., acetone, methyl ethyl ketone), ethers (e.g., diethyl ether, tert-butyl methyl ether, THF), aromatic solvents (toluene, the various regioisomers of xylene, and also mixtures such as solvent naphtha), lactones (e.g., butyrolactone, etc) or lactams (e.g., N-methylpyrrolidone). Preference is given here to aprotic solvents or to solvent mixtures which are composed exclusively, or else at least partially, of aprotic solvents. The modified particles (P) obtained from the particles (P1) can be isolated in powder form by common methods such as, for example, by evaporation of the solvents used or by drying, in a spray dryer, thin-film evaporator or conical dryer, for example.

Alternatively an isolation of the particles (P) may be omitted.

Additionally, in one preferred procedure, following the production of the particles (P), methods of deagglomerating the particles may be employed, such as pinned-disk mills or milling/classifying devices, such as pinned-disk mills, hammer mills, opposed-jet mills, bead mills, ball mills, impact mills or milling/classifying devices.

In a further preferred embodiment of the invention use is made as particles (P1) of organopolysiloxanes of the general formula [4],

[R⁹₃SiO_{1/2}]ᵢ[R⁹₂SiO_{2/2}]ⱼ[R⁹SiO_{3/2}]ₖ[SiO_{4/2}]ₗ [4]

where
R⁹ is an OH function, an optionally halogen-, hydroxyl-, amino-, epoxy-, thiol-, (meth)-acryloyl-, carbamate-, ureido- or else NCO-substituted hydrocarbon radical having 1-18 carbon atoms, it being possible for the carbon chain to be interruped by nonadjacent oxygen, sulfur or NR¹⁰ groups,
R¹⁰ has the definitions of R¹,
i, j, k, and l denote a value of greater than or equal to 0, with the proviso that i+j+k+l is greater than or equal to 3, in particular at least 10, and that at least one radical R⁹ denotes an OH function.

The preparation of the particles (P) from the organopolysiloxanes (P1) of the general formula [4] takes place as described above.

Particular preference as particle (P1) is given to fumed silica, prepared in a flame reaction from organosilicon compounds, such as from silicon tetrachloride or methyl dichlorosilane, for example, or hydrotrichlorosilane or hydromethyldichlorosilane, or other methylchlorosilanes or alkylchlorosilanes, alone or in a mixture with hydrocarbons, or any desired volatilizable or sprayable mixtures of organosilicon compounds as specified, and hydrocarbons, e.g., in an oxygen-hydrogen flame, or else a carbon monoxide-oxygen flame. The preparation of the silica may take place optionally with or without addition of water, in the cleaning step, for example; preferably no water is added.

Pyrogenically prepared silica or silicon dioxide is known, for example, from Ullmann's Enzykopädie der Technischen Chemie, 4^{th} edition, volume 21, page 464. The unmodified fumed silica has a specific BET surface area, measured as per DIN EN ISO 9277/DIN 66132, of 10 m²/g to 600 m²/g, preferably of 50 m²/g to 400 m²/g.

The preparation of the particles (P) from fumed silica may take place by a variety of methods. In one preferred method the dry powderous fumed silica is reacted directly with the very finely divided silanes (S)—where appropriate in mixtures with other silanes (S1), silazanes (S2), siloxanes (S3) or compounds (L).

Methods suitable for producing particles (P) from fumed silica are known and have been widely described. Thus, for example, all of the methods that are described in WO 2006/018144 and entail functionalization of silica preferably in powder form can also be used to produce the particles (P) of the invention. In this case, preferably, the fumed silica is reacted with silanes (S), which are preferably of the formula [2], and, where appropriate, with additional other silanes (S1), silazanes (S2), siloxanes (S3) or other compounds (L).

In another preferred method the fumed silica is reacted not in powder form but instead in dispersions in water or typical solvents employed industrially such as alcohols, such as methanol, ethanol, isopropanol; such as ketones, such as acetone, methyl ethyl ketone; such as ethers, such as diethyl ether, THF; hydrocarbons such as pentane, hexanes; aromatics such as toluene, or other volatile solvents such as hexamethyldisiloxane or mixtures thereof with silanes (S) and, where appropriate, with the silanes (S1), silazanes (S2), siloxanes (S3) or compounds (L).

The method may be carried out continuously or discontinuously and may be composed of one or more steps. A continuous method is preferred. Preferably the modified fumed silica is prepared by means of a method wherein the silica is (1) mixed into one of the abovementioned solvents, (2) reacted with the silanes (S) and, where appropriate, with the silanes (S1), silazanes (S2), siloxanes (S3) or compounds (L), and (3) freed from solvents, excess silanes, and by-products.

Dispersing (1), reacting (2), and drying (3) are preferably carried out in an atmosphere containing less than 10% by volume of oxygen, more preferably less than 2.5% by volume; best results are obtained at less than 1% by volume of oxygen.

The mixing-in (1) may take place by means of conventional mixing assemblies such as anchor stirrers or cross-arm stirrers. Where appropriate, the mixing-in may take place under high shear by means of dissolvers, rotor-stator assemblies, where appropriate with direct feed into the shearing gap, by means of ultrasonic transducers or by means of grinding assemblies such as ball mills. Where appropriate it is possible to use various of the abovementioned assemblies, in parallel or in succession.

For the reacting (2) of the silanes (S) and, where appropriate, of the silanes (S1), silazanes (S2), siloxanes (S3) or compounds (L) with the silica, they are added in pure form or as a solution in suitable solvents to the silica dispersion and mixed homogeneously. The silanes (S) and, where appropriate, the silanes (S1), silazanes (S2), siloxanes (S3) or compounds (L) may be added in the vessel which is used to prepare the dispersion, or in a separate reaction vessel. Where the silanes are added in the dispersing vessel, this may be done in parallel with or after the end of the dispersing operation. Where appropriate, the silanes (S) and, where appropriate, the silanes (S1), silazanes (S2), siloxanes (S3) or compounds (L), in solution in the dispersion medium, may be added directly in the dispersing step.

Where appropriate, water is added to the reaction mixture.

Where appropriate, acidic catalysts such as Brönsted acids such as liquid or gaseous HCl, sulfuric acid, phosphoric acid or acetic acid, or basic catalysts such as Brönsted bases such as liquid or gaseous ammonia, amines such as NEt₃ or NaOH, are added to the reaction mixture.

The reaction step is carried out at a temperature of 0° C. to 200° C., preferably 10° C. to 180° C., and more preferably from 20° C. to 150° C.

The removing of solvents, excess silanes (S) and, where appropriate, the silanes (S1), silazanes (S2), siloxanes (S3) or compounds (L), and by-products (3) may take place by means of dryers or by spray-drying.

The drying step may be followed, where appropriate, by a heat-treatment step to complete the reaction.

In addition, following the drying operation, methods of mechanical compaction of the silica may be employed, such as for example press rolls, grinding assemblies, such as edge runner mills and such as ball mills, continuously or discontinuously, compaction through screws or worm mixers, worm compactors, briquetting machines, or compaction by withdrawal of the air or gas content under suction, by means of suitable vacuum techniques.

In a further particularly preferred procedure the drying is followed by the use of methods of mechanical compaction of the silica, such as compaction through withdrawal of the air or gas content under suction by means of suitable vacuum techniques, or press rolls, or a combination of both methods.

Additionally, in one particularly preferred procedure, the drying may be followed by the use of methods of deagglomerating the silica, such as pinned-disk mills, hammer mills, opposed-jet mills, impact mills or milling/classifying devices.

In the case of a further preferred process for producing the particles (P), the particles (P) are produced via a cohydrolysis of the organosilanes (S) with other silanes (S4) or compounds (L). As silanes (S4) it is possible here to use all hydrolyzable silanes and also silanes containing hydroxysilyl groups. Siloxanes or silazanes may also be employed. Typical examples of suitable silanes (S4) are tetraethoxysilane, tetramethoxysilane, methyltrimeth-oxysilane, phenyltrimethoxysilane, methyltriethoxy-silane, phenyltriethoxysilane, dimethyldimethoxysilane, dimethyldiethoxysilane, trimethylmethoxysilane or trimethylethoxysilane. It is of course also possible to use different mixtures of different silanes (S4). In this context it is possible to use not only mixtures which as well as the silanes (S) contain only silanes (S4) without additional organic functions, but also mixtures which as well as the silanes (S) also contain silanes (S4) without an additional organic function and silanes (S4) with an additional organic function. In the case of the production of the particles (P) via a cohydrolysis, the various silanes may be added jointly or else successively.

The compositions (Z) may comprise one or more different types of particle (P), examples being modified silicon dioxide and also modified aluminum oxide.

Binders (B) employed are both inorganic and organic polymers. Examples of such polymer matrices (B) are polyethylenes, polypropylenes, polyamides, polyimides, polycarbonates, polyesters, polyetherimides, polyether-sulfones, polyphenylene oxides, polyphenylene sulfides, polysulfones (PSU), polyphenylsulfones (PPSU), poly-urethanes, polyvinyl chlorides, polytetrafluoroethylenes (PTFE), polystyrenes (PS), polyvinyl alcohols (PVA), polyether glycols (PEG), polyphenylene oxides (PPO), polyarylether ketones, epoxy resins, polyacrylates, polymethacrylates, and silicone resins.

Polymers which are likewise suitable as binders (B) are oxidic materials which are obtainable by common sol-gel methods known to the skilled worker. According to the sol-gel method, hydrolyzable and condensable silanes and/or organometallic reagents are hydrolyzed by means of water, and in the presence of a catalyst where appropriate, and are cured by suitable techniques to form the silicatic or oxidic materials.

Where the silanes or organometallic reagents carry organofunctional groups (such as epoxy, methacryloyl, amine groups, for example) which can be employed for crosslinking, these modified sol-gel materials may additionally be cured via their organic component. The curing of the organic component may take place, where appropriate after addition of further reactive organic components—by thermal means or by UV irradiation, among other methods. In this way, for example, sol-gel materials suitable as matrix (B) are materials which are obtainable by reaction of an epoxy-functional alkoxysilane with an epoxy resin, and in the presence of an amine curing agent where appropriate. A further example of such organic-inorganic polymers are sol-gel materials (B) which are preparable from amino-functional alkoxysilanes and epoxy resins. Through the incorporation of the organic component it is possible, for example, to improve the elasticity of a sol-gel film. Organic-inorganic polymers of this kind are described for example in Thin Solid Films 1999, 351, 198-203.

It is also possible, moreover, to use reactive resins as binders (B). Reactive resins in this context are compounds which possess one or more reactive groups. Examples of reactive groups here include hydroxyl, amino, isocyanate, epoxide, and mercapto groups, ethylenically unsaturated groups, and also moisture-crosslinking alkoxysilyl groups. In the presence of a suitable curing agent (H) and/or an initiator, the reactive resins can be polymerized by thermal treatment, actinic radiation and/or (atmospheric) moisture. The reactive resins may be present in monomeric, oligomeric, and polymeric form. Examples of common reactive resins are as follows: hydroxy-functional resins such as hydroxyl-containing polyacrylates or polyesters, for example, which can be crosslinked with isocyanate-functional curing agents (H); resins with acrylic and methacrylic functionality, which, following addition of an initiator, can be cured thermally, by actinic radiation or by an amino-functional curing agent (H); epoxy resins, which can be crosslinked with amine curing agents (H); vinyl-functional siloxanes, which can be crosslinked by reaction with an SiH-functional curing agent (H); and SiOH-functional siloxanes, which can be cured through a polycondensation.

The binders (B) are preferably carbinol-, (meth)acrylate-, epoxy-, and isocyanate-functional resins. For the production of coating systems it is preferred as film-forming resins to use hydroxyl-containing prepolymers, more preferably hydroxyl-containing polyacrylates or polyesters. Hydroxyl-containing polyacrylates and polyesters of this kind that are suitable for producing coating materials are well known to the skilled worker and are much described in the relevant literature. They are produced and sold by numerous manufacturers.

Also suitable as binders (B), moreover, are mixtures of different matrix polymers, corresponding copolymers, and also monomeric, oligomeric, and polymeric reactive resins.

Compounds used as curing agents (H) are the compounds typically used for the above-identified binders (B). Examples of suitable curing agents are amino-, epoxy-, isocyanato-functional monomers, oligomers or polymers.

The compositions (Z) which find use more particularly as a coating system may be 1-component (1K) or else 2-component (2K) systems. In the first case, the curing agents (H) used are preferably compounds which possess protected isocyanate groups. In the second case, curing agents (H) used are preferably compounds with free isocyanate groups. In both 1K and 2K coating materials, isocyanates used are common diisocyanates and/or polyisocyanates, which where appropriate have been provided beforehand with the respective protective groups. Use is made in this context in principle of all common isocyanates, as are widely described in the literature. Examples of common diisocyanates are diiso-cyanatodiphenylmethane (MDI), in the form both of crude or technical MDI and of pure 4,4′- or 2,4′-isomers or mixtures thereof, tolylene diisocyanate (TDI) in the form of its various regioisomers, diisocyanatonaphthalene (NDI), isophorone diisocyanate (IPDI), perhydrogenated MDI (H-MDI), tetramethylene diisocyanate, 2-methylpentamethylene diisocyanate, 2,2,4-trimethylhexamethylene diisocyanate, dodecamethylene diisocyanate, 1,4-diisocyanatocyclohexane, 1,3-diisocyanato-4-methylcyclohexane or else hexamethylene diisocyanate (HDI). Examples of polyisocyanates are polymeric MDI (P-MDI), triphenylmethane triisocyanate, and also all isocyanurate trimers or biuret trimers of the above-recited diisocyanates. In addition it is also possible to use further oligomers of the abovementioned isocyanates with blocked NCO groups. All diisocyanates and/or polyisocyanates can be used individually or else in mixtures. Preference in this context is given to using the isocyanurate trimers and biuret trimers of the comparatively UV-stable aliphatic isocyanates, more preferably the trimers of HDI and IPDI.

Where isocyanates with protected isocyanate groups are used as curing agents (H), preferred protective groups are those which are eliminated at temperatures of 80 to 200° C., more preferably at 100 to 170° C. Protective groups which can be used are secondary or tertiary alcohols, such as isopropanol or tert-butanol, CH-acidic compounds such as diethyl malonate, acetylacetone, ethyl acetoacetate, for example, oximes such as formaldoxime, acetaldoxime, butane oxime, cyclohexanone oxime, acetophenone oxime, benzophenone oxime or diethylene glyoxime, for example, lactams, such as caprolactam, valerolactam, butyrolactam, for example, phenols such as phenol, o-methylphenol, N-alkylamides such as N-methylacetamide, for example, imides such as phthalimide, secondary amines such as diisopropylamine, imidazole, 2-isopropylimidazole, pyrazole, 3,5-dimethylpyrazole, 1,2,4-triazole, 2,5-dimethyl-1,2,4-triazole, for example. Preference is given to using protective groups such as butane oxime, 3,5-dimethylpyrazole, caprolactam, diethyl malonate, demethyl malonate, ethyl acetoacetate, diisopropylamine, pyrrolidone, 1,2,4-triazole, imidazole, and 2-isopropylimidazole. Particular preference is given to using protective groups which allow a low baking temperature, such as diethyl malonate, dimethyl malonate, butane oxide, diisopropylamine, 3,5-dimethylpyrazole, and 2-isopropylimidazole, for example.

The ratio of blocked to unblocked isocyanate groups to the isocyanate-reactive groups of film-forming resin (B) in the composition (Z) is typically 0.5 to 2, preferably 0.8 to 1.5, and more preferably 1.0 to 1.2.

Also suitable as curing agents (H), moreover, are mixtures of different curing agents (H).

The compositions (Z) may, moreover, acquire common solvents and also the adjuvants and additives that are customary in formulations. Instances thereof here would include, among others, flow control assistants, surface-active substances, adhesion promoters, light stabilizers such as UV absorbers and/or free-radical scavengers, thixotropic agents, and other solids and fillers. To produce the particular profiles of properties that are desired, both for the compositions (Z) and for the composites (K), adjuvants of this kind are preferred.

The composite materials (K) are produced preferably in a two-stage process. In a first stage, the particles (P), the binder (B), and, where appropriate, the curing agent (H) and further additives and adjuvants are mixed to produce the compositions (Z). In a second step, the compositions (Z) are converted into the composite materials (K) by curing, i.e., by drying, by reaction between binder (B) and curing agent (H), by (atmospheric) moisture and/or by treatment with thermal or actinic radiation.

In one preferred embodiment, the compositions (Z) are produced by dispersing or dissolving the binder (B), the particles (P), and also, where appropriate, the curing agent (H) and, where appropriate, further adjuvants in a solvent or solvent mixture. Solvents or solvent mixtures having a boiling point or boiling range of up to 120° C. at 0.1 mPa are preferred. Suitable solvents are ethers such as THF, for example, alcohols such as methanol, ethanol, isopropanol, for example, esters such as butyl acetate, for example, aromatic hydrocarbons such as toluene and xylenes, for example, linear and branched aliphatic solvents such as pentane, hexane, dodecane, for example, and also dimethylformamide, dimethylacetamide, methoxypropyl acetate, dimethyl sulfoxide, N-methyl-2-pyrrolidone, and water. To disperse the particles (P) in the composition (Z) it is possible to use further adjuvants and additives typically used for dispersing. These include Brönstedt acids, such as hydrochloric acid, phosphoric acid, sulfuric acid, nitric acid, trifluoroacetic acid, acetic acid, methylsulfonic acid, for example, Brönstedt bases, such as triethylamine and ethyldiisopropylamine, for example. Moreover, as further adjuvants, it is possible to use all of the protective colloids and/or emulsifiers that are typically used. Examples of protective colloids are polyvinyl alcohols, cellulose derivatives or vinylpyrrolidone-containing polymers. Customary emulsifiers are, for example, ethoxylated alcohols and phenols (alkyl radical C₄-C₁₈, EO degree 3-100), alkali metal salts and ammonium salts of alkyl sulfates (C₃-C₁₈), sulfuric esters and phosphoric esters, and alkylsulfonates. Particular preference is given to sulfosuccinic esters and also to alkali metal alkyl sulfates and also polyvinyl alcohols. It is also possible to use two or more protective colloids and/or emulsifiers in the form of a mixture. For dispersing the particles (P), there is preferably no need for any adjuvants.

For dispersing the particles (P) in the composition (Z) it may be useful to carry out the incorporation of the particles by means of bead mills, ultrasound treatment or other common stirring mechanisms.

Alternatively the compositions (Z) and also the composites (K) may be produced in a melting or extrusion operation, starting from particles (P), binders (B), and, where appropriate, a curing agent (H) and further adjuvants.

Alternatively the composition (Z) may be produced by modifying particles (P1) in the binder (B) or in a mixture of binder (B), curing agent (H), and, where appropriate, further adjuvants. For that purpose the particles (P1) are dispersed in the binder (B) and subsequently reacted with the silanes (S) to give the particles (P).

In the case of one preferred process the compositions (Z) are produced by adding the particles (P) during a mixing operation as a powder or as a dispersion in a suitable solvent. In addition, however, a further process is preferred in which first a masterbatch is produced from particles (P) and from one or more components of the composition (Z), featuring particle concentrations >15% by weight, preferably >25% by weight, and more preferably >30% by weight. In the case of the production of the compositions (Z), this masterbatch is then mixed with the other components. Where the masterbatch is produced starting from a particle dispersion, it may be advantageous if the solvent of the particle dispersion is removed in the course of the production of the masterbatch, via a distillation step, for example, or else replaced by another solvent or solvent mixture.

Where the compositions (Z) comprise aqueous or organic solvents, the corresponding solvents are removed, where appropriate, after the composition (Z) has been produced. The removal of the solvent in this case is accomplished preferably by distillation. Alternatively the solvent may remain in the composition (Z) and be removed in the course of the production of the composite material (K), by drying.

To produce the composite materials (K) the compositions (Z) are preferably applied to a substrate by knife coating. Further methods are dipping, spraying, casting, and extrusion operations. Suitable substrates include glass, metal, wood, silicon wafers, and plastics such as polycarbonate, polyethylene, polypropylene, polystyrene, and PTFE, for example.

Where the compositions (Z) comprise reactive resins (B), curing is accomplished preferably, following addition of a curing agent (H) or initiator, by actinic radiation or thermal energy. The curing conditions in this case correspond to those of the particle-free compositions.

Where the particles (P) carry organofunctional groups which are reactive toward the binder (B) or the curing agent (H), the particles (P) can be attached covalently to the binder (B) or the curing agent.

In the composite material (K) the particles (P) may have a distribution gradient or may be distributed homogeneously. In one particular embodiment of the invention the concentration of particles (P) is higher at the coating/air interface than in the bulk segment and at the coating/substrate interface. The coating/air interface here means the near-interface layer, which has a thickness of not more than 150 nm. Alternatively, the concentration of particles (P) may be higher at the coating/substrate interface than in the bulk segment, and at the coating/air interface. The coating/substrate interface here means the near-interface layer, which has a thickness of not more than 150 nm. In one further preferred embodiment of the invention the concentration of particles (P) is higher both at the coating/air interface and at the coating/substrate interface than in the bulk segment. Depending on the matrix system selected, both a homogeneous distribution and a nonuniform distribution of the particles may produce an increase, for example, in the mechanical stability, the chemical resistance, the corrosion stability, and the adhesion.

On the basis of the outstanding chemical, thermal, and mechanical properties of the composite materials (K) produced from them, the compositions (Z) may be employed in particular as adhesives, sealants, sealing compounds, encapsulating compounds, and dental compounds.

With particular preference the composite materials (K) produced from the compositions (Z) serve as scratch-resistant clearcoats or topcoats, more particularly in the vehicle industry, as OEM finishes and refinishes. The compositions (Z) can be applied by any desired methods, such as dipping, spraying, and casting methods. Also possible is the application of the compositions (Z) to a basecoat by a wet-in-wet process. Curing takes place in general by heating under the particular conditions required (2K coatings typically at 0-100° C., preferably at 20-80° C.; 1K coatings at 100-200° C., preferably at 120-160° C.). Of course, the curing of the composition (Z) may be accelerated through the addition of suitable catalysts. Catalysts suitable in this context include, more particularly, acidic, basic, and also heavy-metal compounds.

All of the above symbols in the above formulae have their definitions in each case independently of one another. In all formulae the silicon atom is tetravalent.

Unless indicated otherwise, all amounts and percentages are by weight, all pressures are 0.10 mPa (abs.), and all temperatures are 20° C.

### EXAMPLE 1

### Synthesis of Phosphonate-Functional Particles from an Aqueous Silica Sol

A solution of 1.96 g of diethylphosphonatomethyl-dimethylmethoxysilane in 40 ml of methoxypropyl acetate was added dropwise over the course of 10 minutes, with vigorous stirring, to 14.0 g of an aqueous silica sol (LUDOX® AS 40 from GRACE DAVISON, 24 nm, 40% by weight) and the mixture was heated at 60° C. for 4 hours. Subsequently the resulting milky emulsion was concentrated under reduced pressure until a transparent silica sol was obtained. The average particle size of the modified silica sol, determined by means of dynamic light scattering (Zetasizer Nano from Malvern), was 32 nm. After distillative removal of the solvent, 7.16 g of a colorless solid were obtained which was redispersible in isopropanol by stirred incorporation. The average particle size of the silica sol in isopropanol was 44 nm.

### EXAMPLE 2

### Synthesis of Phosphonate-Functional Particles from an Organic Silica Sol

A mixture consisting of 480 g of a silica sol in isopropanol (IPA-ST from NISSAN CHEMICAL, 12 nm, 30% by weight) and 48.0 g of diethylphosphonatomethyldimethyl-methoxysilane was heated at 60° C. for 6 hours. The average particle size of the modified silica sol, determined by means of dynamic light scattering (Zetasizer Nano from Malvern), was 13 nm. After distillative removal of the solvent, 191 g of a colorless solid were obtained which was redispersible both in acetone and in isopropanol by stirred incorporation. The average particle size of the silica sol in isopropanol was 14.5 nm.

### EXAMPLE 3

### Synthesis of Phosphonate-Functional Particles which Possess Protected Isocyanate Functions

A mixture consisting of 48.0 g of a silica sol in isopropanol (IPA-ST from NISSAN CHEMICAL, 12 nm, 30% by weight), 4.32 g of diethylphosphonatomethyldimethyl-methoxysilane, and 0.48 g of the protected isocyanatosilane [5] was heated at 60° C. for 6 hours.

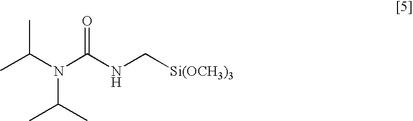

The average particle size of the modified silica sol, determined by means of dynamic light scattering (Zetasizer Nano from Malvern), was 12 nm. After distillative removal of the solvent, 184 g of a colorless solid were obtained which was redispersible both in acetone and in isopropanol by stirred incorporation. The average particle size of the silica sol in isopropanol was 23 nm.

### EXAMPLE 4

### Production of a Particle-Reinforced Epoxy Resin

7.48 g of the powderous particle described in Example 2 were dispersed in 30 ml of acetone. The transparent silica sol was then added dropwise to a solution of 30.0 g of epoxy resin D.E.R. 332 (DOW CHEMICAL) and 8.00 g of 4-aminophenyl sulfone in 100 ml of acetone. Following distillative removal of the solvent under reduced pressure, the low-viscosity mixture was poured into an aluminum tray and cured at 190° C. for 30 minutes and at 240° C. for 3 hours. This gave a transparent solid having a thickness of 6 mm. Electron micrographs showed that the particles employed are in isolation in the composite.

### EXAMPLE 5

### Production of a Particle-Containing 1K PU Coating Formulation

To produce a coating formulation, an acrylate-based paint polyol having a solids content of 52% by weight and an OHN of 156 (Parocryl® 54.4 from BASF AG) is mixed with Desmodur® BL 3175 SN from Bayer AG (butane oxime-blocked polyisocyanate, having a SC of 75% by weight and a blocked NCO content of 11.1%). In addition, 1% by weight of dibutyltin dilaurate (1% strength in butyl acetate) and 1% by weight of TEGO ADDID® 100 from TEGO AG (flow control assistant based on polydimethylsiloxane; 10% strength solution in butyl acetate) are mixed in, and also the modified silica sols of Examples 1-3, giving coating formulations with a solids content of approximately 60% by weight. The amounts of the respective components used in these formulations are listed in Table 1. The mixtures, which to start with are still slightly turbid, are stirred at room temperature for 24 hours, giving clear coating formulations (blends 2-5).

TABLE 1

| | | | Modified | |
|---|---|---|---|---|
| | | | silica sol | Particle |
| | | | (50% by | content |
| | Parocryl ® | Desmodur ® | weight in | (in % by |
| | 54.4 | BL 3175 SN | acetone)** | weight) |
| Blend 1 | 10.00 g | 6.03 g | 0.0 g | 0.0 |
| (comparative*) | | | | |
| Blend 2 | 10.00 g | 6.03 g | 0.3 g | 1.5 |
| | | | (particles | |
| | | | from | |
| | | | Example 2) | |
| Blend 3 | 10.00 g | 6.03 g | 0.3 g | 1.5 |
| | | | (particles | |
| | | | from | |
| | | | Example 1) | |
| Blend 4 | 10.00 g | 6.03 g | 0.6 g | 3.0 |
| | | | (particles | |
| | | | from | |
| | | | Example 2) | |
| Blend 5 | 10.00 g | 6.03 g | 0.6 g | 3.0 |
| | | | (particles | |
| | | | from | |
| | | | Example 3) | |

*not inventive
**particles of Examples 1-3, isolated in powder form, were predispersed in acetone

### EXAMPLE 6

### Production of a Particle-Containing 2K PU Coating Formulation

To produce a coating formulation, an acrylate-based paint polyol having a solids content of 65% by weight and an OHN of 180 (Parocryl® 49.5 from BASF AG) is diluted with 20% by weight of butyl acetate, mixed with the modified silica sol of Examples 2 or 3, and stirred at room temperature for 24 hours. Following addition of the curing component Basonat 100 from BASF Coatings (aliphatic polyisocyanate based on isocyanuratized hexamethylene diisocyanate, NCO content 22% by weight) and 1% by weight of ADDID® 100 from TEGO AG (flow control assistant based on polydimethylsiloxane; 10% strength solution in butyl acetate) the mixture is stirred for a further 5 hours, giving clear coating formulations (blends 7-10) with a solids content of approximately 50% by weight. The amounts of the respective components that are employed for these formulations are listed in Table 2.

TABLE 2

| | | | Modified | |
|---|---|---|---|---|
| | | | silica sol | Particle |
| | | | (50% by | content |
| | Parocryl ® | Basonat ® | weight in | (in % by |
| | 49.5 | HI 100 | acetone)** | weight) |
| Blend 6 | 10.00 g | 4.40 g | 0.0 g | 0.0 |
| (comparative*) | | | | |
| Blend 7 | 10.00 g | 4.40 g | 0.33 g | 1.5 |
| | | | (particles | |
| | | | from | |
| | | | Example 2) | |
| Blend 8 | 10.00 g | 4.40 g | 0.66 g | 3.0 |
| | | | (particles | |
| | | | from | |
| | | | Example 2) | |
| Blend 9 | 10.00 g | 4.40 g | 1.31 g | 6.0 |
| | | | (particles | |
| | | | from | |
| | | | Example 2) | |
| Blend 10 | 10.00 g | 4.40 g | 0.66 g | 3.0 |
| | | | (particles | |
| | | | from | |
| | | | Example 3) | |

*not inventive
**particles of Examples 1-3, isolated in powder form, were predispersed in acetone

### EXAMPLE 7

### Production and Evaluation of Coating Films from the Blends of Examples 5 and 6

The coating materials from Examples 5 and 6 are each knife-coated onto a glass plate using a film-drawing device, the Coatmaster® 509 MC from Erichsen, with a doctor blade having a slot height of 120 μm. The coating films obtained are then dried in a forced-air drying oven at 70° C. for 30 minutes and then at 150° C. for 30 minutes. The blends 1-10 of Examples 5 and 6 produce optically flawless, smooth coatings. The gloss of the coatings is determined using a Micro gloss 20° gloss meter from Byk, and for all of the coatings is between 160 and 170 gloss units.

The scratch resistance of the cured coating films thus produced is determined using a Peter-Dahn abrasion tester. For this purpose, a Scotch Brite® 2297 abrasive pad with an area of 45×45 mm is weighed with a weight of 500 g. Using this pad, the film samples are scratched with a total of 50 strokes. Both before the beginning and after the end of the scratch tests, the gloss of the respective coating is measured using a Micro gloss 20° gloss meter from Byk. The measure defined for the scratch resistance of the respective coating was the loss in gloss in comparison to the initial value:

| Coating sample from | Loss of gloss |
|---|---|
| Blend 1 (comparative*) | 70% |
| Blend 2 | 19% |
| Blend 3 | 25% |
| Blend 4 | 18% |
| Blend 5 | 14% |
| Blend 6 (comparative*) | 53% |
| Blend 7 | 30% |
| Blend 8 | 35% |
| Blend 9 | 30% |
| Blend 10 | 25% |

*not inventive

The results show that even small levels of the particles (P) lead to a significant increase in the scratch resistance of the corresponding coating. Moreover, an increase in scratch resistance is observed for coating materials which comprise particles (P) that possess functions (F) that are reactive toward the binder (B) (coating samples from blends 5 and 10).

1. A composition (Z) comprising
(a) 0.02-200 parts by weight of particles (P) which contain at least one structural element of the formula [1],
≡Si—L—P(O)(OR¹)₂ [1]
(b) 100 parts by weight of a binder (B),
(c) 0-100 parts by weight of a curing agent (H) which is reactive with the binder (B), and
(d) 0-1000 parts by weight of a solvent or solvent mixture, where
L is a divalent aliphatic or aromatic hydrocarbon radical having 1 to 12 carbon atoms, whose carbon chain is optionally interrupted by nonadjacent oxygen atoms, sulfur atoms or NR² groups, and which is optionally substituted by carbinol, amino, halogen, epoxy, phosphonato, thiol, (meth)acrylato, ureido, or carbamato groups,
R¹ is hydrogen, a metal cation, an ammonium cation of the formula —N(R²)₄⁺, a phosphonium cation of the formula —P(R²)₄⁺, or an aliphatic or aromatic hydrocarbon radical having up to 12 carbon atoms, whose carbon chain may be interrupted by nonadjacent oxygen atoms, sulfur atoms or NR² groups, and which is optionally substituted by carbinol, amino, halogen, epoxy, phosphonato, thiol, (meth)acrylato, carbamato, or ureido groups, and
R² is a hydrocarbon radical having 1-8 carbon atoms.

2. The composition (Z) of claim 1, wherein the particles (P) besides functions of the formula [1] further contain at least one organofunctional group (F) which is reactive toward the binder (B) or the curing agent (H).

3. The composition (Z) of claim 1, wherein L is a methylene or propylene radical.

4. The composition (Z) of claim 1, wherein R¹ is an alkyl radical having 1-6 carbon atoms.

5. The composition (Z) of claim 1, wherein the particles (P) possess a specific surface area of 10 to 500 m²/g, as measured by the BET method in accordance with DIN EN ISO 9277/DIN 66132.

6. A composite material (K) produced by curing a composition (Z) of claim 1.

7. The composite material (K) of claim 6, which is a coating system which is produced by curing a coating composition (Z) comprising
(a) 0.02-60 parts by weight of particles (P) which contain at least one structural element of the formula [1],
≡Si—L—P(O)(OR¹)₂ [1]
(b) 100 parts by weight of a hydroxyl-functional film-forming resin (B),
(c) 1-100 parts by weight of a coatings curing agent (H) which contains free isocyanate groups, protected isocyanate groups which on thermal treatment eliminate a protective group to release an isocyanate function, or mixtures thereof, and
(d) 0-1000 parts by weight of a solvent or solvent mixture.

8. The composition (Z) of claim 1 which is an adhesive, sealant, sealing compound, encapsulating compound, dental compound, or coating material.
